(19) United States
(12) Patent Application Publication
(10) Pub. No.: US 2011/0179350 A1
(43) Pub. Date: Jul. 21, 2011

(54) AUTOMATICALLY PLACING AN ANCHOR FOR AN OBJECT IN A DOCUMENT

(75) Inventors: Jay C. Capela, Santa Cruz, CA (US); Christopher E. Rudolph, Camas, WA (US); Matthew T. Schomer, Santa Cruz, CA (US)

(73) Assignee: APPLE INC., Cupertino, CA (US)

(21) Appl. No.: 12/688,613

(22) Filed: Jan. 15, 2010

(51) Int. Cl. G06F 17/00

(52) U.S. Cl. 715/244

(57) ABSTRACT

The described embodiments provide a system for formatting a document in a word processor. During operation, upon receiving a command to move an object in the document, the system moves the object in the document. When moving the object in the document, the system dynamically arranges other content in the document with respect to the object. Upon receiving a command to place the object in a specified location while moving the object, the system places the object at the specified location and leaves the other content arranged with respect to the object in accordance with a most recent dynamic arrangement. After placing the object at the specified location, the system determines an anchor location for an anchor for the object and places an anchor for the object in the anchor location.

### RELATED APPLICATIONS

This application is related to U.S. patent application Ser. No. ______, titled “Automatically Wrapping Text in a Document,” by inventors Jay C. Capela, Matthew T. Schomer, and Christopher E. Rudolph, filing date ______ (attorney docket number APL-P8613US1). This application is also related to U.S. patent application Ser. No. ______, titled “Automatically Configuring Whitespace around an Object in a Document,” by inventors Jay C. Capela and Matthew T. Schomer, filing date ______ (attorney docket no. APL-P8615US1).

### BACKGROUND

1. Field

The described embodiments relate to techniques for formatting documents in a word processor. More specifically, the described embodiments relate to a technique for automatically placing an anchor for an object in a document in a word processing application.

2. Related Art

Modern word processors include numerous features to assist with creating and editing documents. For example, virtually all word processors enable the placement and formatting of both text and objects such as tables, images, and charts in a document. In doing so, the word processors enable users to place objects in documents at specified locations, and to move, resize, and manipulate objects when they have been placed in a document.

Some word processors associate an “anchor” with each object in a document. In these word processors, when a user places an object at a given location in a document, the word processor inserts the anchor at a corresponding location in the document. For example, if the user uses a mouse-controlled cursor to place an object in a document, the word processor can place the anchor at the location indicated by the cursor. The word processor then uses the anchor to determine the arrangement of text and the other objects in the document relative to the object. For example, FIG. 1 presents a block diagram illustrating a document 100 that includes an exemplary anchor 106 for object 104 in a section of text 102. As can be seen in FIG. 1, the section of text 102 is divided to accommodate object 104 at a point defined by anchor 106.

In some word processors, a user repositions an object by selecting the object and dragging the anchor for the object to a new location. When the user releases the anchor to place the object in a given location, the word processor uses the repositioned anchor to determine a placement for the object and arrange the text and other objects in the document around the object. In many instances, the rules that are used by the word processor to arrange text and other objects around a repositioned object may be unclear to a user. Thus, when a user drags the anchor to a new location in the document, expecting that the surrounding text will be arranged in a particular way when the word processor places the object in a location dictated by the anchor, the user may be frustrated when the word processor instead arranges the text in a different and unanticipated way.

For example, FIGS. 2A-2B present a block diagram illustrating a case where the word processor has arranged a section of text 102 in an unexpected way as a user moves an anchor 106 to reposition an object 104. As can be seen in FIG. 2A, anchor 106 has been dragged from the position shown in FIG. 1 in a leftward direction and placed in the illustrated location as a user attempts to shift object 104 to the left. Because anchor 106 has been repositioned, the word processor determines that there is sufficient space in the final line of text above object 104 to contain object 104. As shown in FIG. 2B, the word processor then splits the final line of text to place object 104, moving the underlined portion of the text from the final line to a location below object 104. Because the user only attempted to move anchor 106 (and hence object 104) to the left, the splitting of the line and associated rearrangement of the text can be unexpected and surprising for the user.

### SUMMARY

The described embodiments provide a word processor for formatting a document. During operation, in response to receiving a command to move an object in the document, the word processor moves the object in the document. In doing so, the word processor dynamically arranges other content in the document as the object is moved. Next, upon receiving a command to place the object in a specified location while moving the object, the word processor places the object at the specified location and leaves the other content arranged in accordance with a most recent dynamic arrangement. After placing the object at the specified location, the word processor determines a location for an anchor for the object. The word processor then places the anchor for the object in the determined anchor location.

In some embodiments, when receiving the command to move the object, the word processor receives a selection of the object from a user and a command to drag or otherwise move the object to the specified location. In some embodiments, when receiving the command to place the object at the specified location, the word processor receives a command to stop dragging or moving the object and to place the object at the specified location.

In some embodiments, before receiving the command to move the object, the object is located in an initial location, wherein the initial location is associated with a corresponding initial anchor location. The word processor keeps the anchor at the initial anchor location until the anchor is placed at a new anchor location.

In some embodiments, the word processor displays the object and the dynamically arranged content to a user as the object is moved.

In some embodiments, when determining the anchor location, the word processor first determines a location or property of at least one semantic element of the other content. The word processor then uses the determined location or property to determine the anchor location.

In some embodiments, when determining the anchor location, the word processor determines a location where a user will likely expect to select the object during a drag-select operation. The word processor then adjusts the anchor location to account for the location where the user will likely expect to select the object during the drag-select operation.

In some embodiments, when moving the object, the word processor determines if the word processor has been configured not to display the anchor for the object as the object is moved and, if so, the word processor does not display the anchor for the object as the object is moved.

In some embodiments, the anchor is a special character, a pointer, a reference in a table, or another indicator used by the word processor to determine the location of the object and to arrange other content relative to the object.

In some embodiments, after placing the anchor at the anchor location, the word processor receives text or other objects to add to the other content. The word processor then adds the text or other objects to the other content and repositions the anchor to maintain the arrangement of the other content with respect to the object.

In some embodiments, the word processor is an application that is executed using a processing subsystem in a computer system.

### BRIEF DESCRIPTION OF THE FIGURES

FIG. 1 presents a block diagram illustrating a document that includes an exemplary anchor for an object in a section of text.

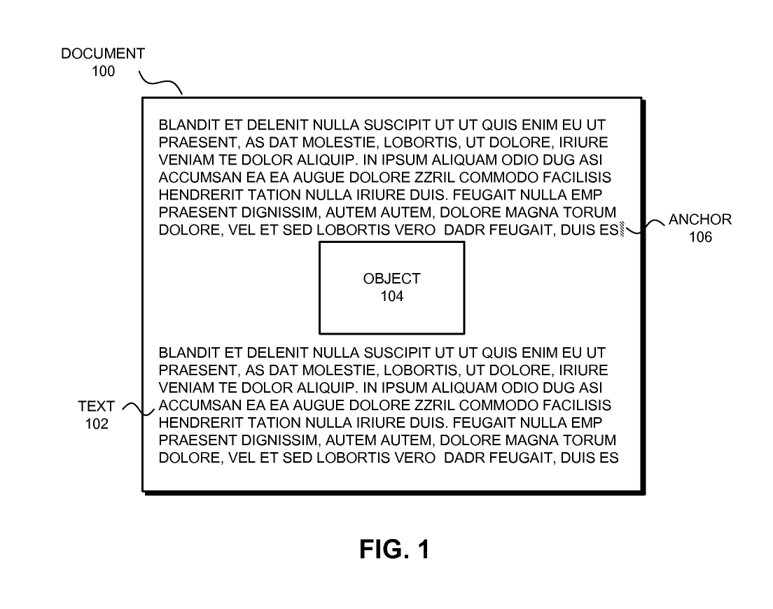

FIGS. 2A-2B present block diagrams illustrating a case where the word processor has arranged a section of text in a document in an unexpected way.

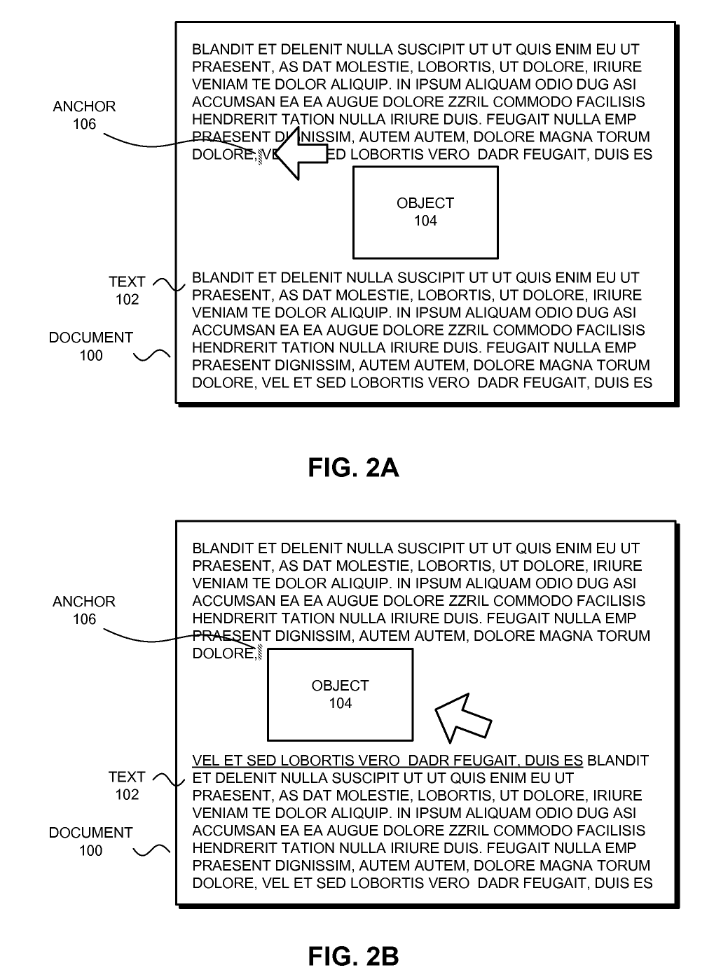

FIG. 3 presents a block diagram illustrating a computer system in accordance with the described embodiments.

FIG. 4 presents a block diagram illustrating a network in accordance with the described embodiments.

FIG. 5 presents a block diagram illustrating a word processor in accordance with the described embodiments.

FIG. 6 presents a block diagram illustrating a document that includes an anchor that moves as text is added to the document in accordance with the described embodiments.

FIGS. 7A-7C present block diagrams illustrating the repositioning of an object in a document in accordance with the described embodiments.

FIG. 8 presents a flowchart illustrating a process for repositioning an object in a document in accordance with the described embodiments.

Throughout the figures and the description, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

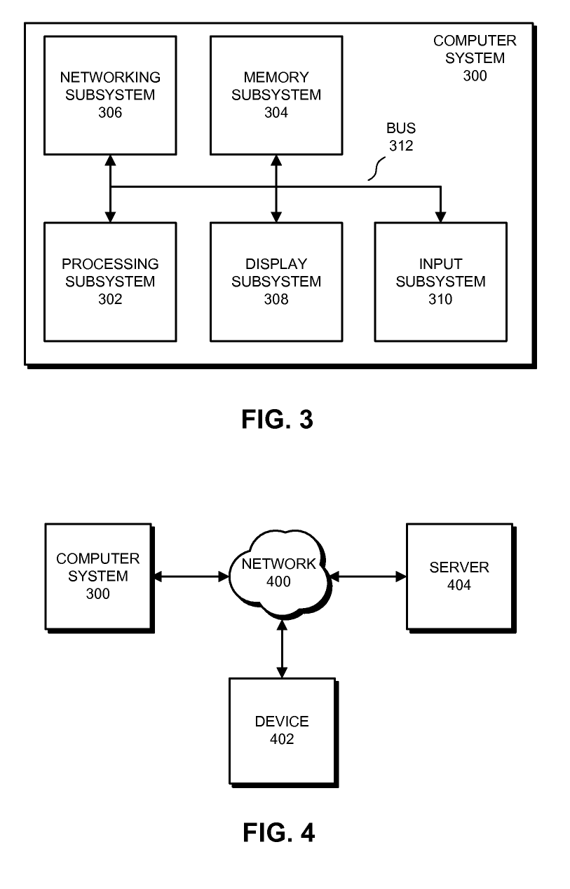

The data structures and code described in this detailed description can be stored on a computer-readable storage medium. The computer-readable storage medium can include any device or medium (or combination of devices and/or mediums) that can store data structures and code for use by a computer system. For example, the computer-readable storage medium can include volatile memory or non-volatile memory, including flash memory, random access memory (RAM, SRAM, DRAM, RDRAM, DDR/DDR2/DDR3 SDRAM, etc.), read-only memory (ROM), magnetic or optical storage devices (e.g., disk drives, magnetic tape, CDs, DVDs), or other mediums capable of storing data structures or code. In the described embodiments, the computer-readable storage medium can be included in memory subsystem 304 (see FIG. 3) or in another of the subsystems in computer system 300.

Some or all of the methods and processes described in the following description can be embodied as program code that is stored in a computer-readable storage medium. When a computer system (e.g., computer system 300) reads and executes the program code stored on the computer-readable storage medium, the computer system performs the methods and processes in the program code stored in the computer-readable storage medium.

Some or all of the methods and processes described in the following description can be included in hardware modules. For example, the hardware modules can include, but are not limited to, application-specific integrated circuit (ASIC) chips, field-programmable gate arrays (FPGAs), and other programmable-logic devices. When the hardware modules are activated, the hardware modules perform the methods and processes included within the hardware modules. In some embodiments, the hardware modules include one or more general-purpose circuits (e.g. general-purpose circuits in processing subsystem 302) that can be configured by executing instructions to perform the methods and processes.

### Computer System

FIG. 3 presents a block diagram illustrating a computer system 300 in accordance with the described embodiments. Computer system 300 includes processing subsystem 302, memory subsystem 304, networking subsystem 306, display subsystem 308, and input subsystem 310.

Processing subsystem 302 can include one or more devices configured to perform computational operations. For example, processing subsystem 302 can include, but is not limited to, one or more microprocessors, ASICs, microcontrollers, or programmable-logic devices.

Memory subsystem 304 can include one or more devices and/or computer readable storage mediums for storing data and/or instructions for processing subsystem 302 and networking subsystem 306. For example, memory subsystem 304 can include DRAM, flash memory, and/or other types of memory. In addition, memory subsystem 304 can include mechanisms for controlling access to the memory. In some embodiments, memory subsystem 304 includes a memory hierarchy that includes an arrangement of one or more caches coupled to a memory for computer system 300. In some of these embodiments, one or more of the caches is located in processing subsystem 302.

In some embodiments, memory subsystem 304 is coupled to one or more high-capacity mass-storage devices (not shown). For example, memory subsystem 304 can be coupled to a magnetic or optical drive, a solid-state drive, or another type of mass-storage device. In these embodiments, memory subsystem 304 can be used by computer system 300 as fast-access storage for often-used data, while the mass-storage device is used to store less frequently accessed data.

Networking subsystem 306 can include one or more devices configured to communicate on a corresponding wired and/or wireless network. Networking subsystem 306 can include controllers, radios/antennas for wireless network connections, sockets/plugs for hard-wired electrical connections, and/or other devices used for coupling to, communicating on, and handling data and events on a wired and/or wireless network.

Display subsystem 308 can include one or more devices configured for displaying output from computer system 300 on a display device (not shown). For example, display subsystem 308 can display output from computer system 300 on a monitor, a screen, a touch screen, and/or another display device.

Input subsystem 310 can include one or more devices configured to receive commands, text, and data input by a user or another device, and forward the received input to the other subsystems in computer system 300. For example, input subsystem 310 can receive input from a keyboard, a mouse, a stylus, a touch screen in the display, and/or another input device.

Within computer system 300, the subsystems (i.e., processing subsystem 302, memory subsystem 304, networking subsystem 306, display subsystem 308, and input subsystem 310) are coupled together using bus 312. Bus 312 is an electrical connection that the subsystems can use to communicate commands and data between one another. Although only one bus 312 is shown for clarity, different embodiments can include a different number or configuration of electrical connections between the subsystems.

Although shown as separate subsystems in FIG. 3, in some embodiments, some or all of a given subsystem can be integrated into one or more of the other subsystems in computer system 300. For example, as described above, one or more caches in memory subsystem 304 can be included in processing subsystem 302 and/or another of the subsystems. Although alternative embodiments can be configured in this way, for clarity we describe the subsystems separately.

Computer system 300 can be incorporated into many different types of electronic devices. Generally, these electronic devices include any device that executes a word processor that can automatically place an anchor for an object in a document. For example, computer system 300 can be part of a desktop computer, a laptop computer, a server, a media player, an appliance, a subnotebook/netbook, a cellular phone, a network appliance, a tablet computer, a set-top box, a personal digital assistant (PDA), a smart phone, a toy, a controller, or another device.

Although we use specific components to describe computer system 300, in alternative embodiments, different components and/or subsystems may be present in computer system 300. For example, computer system 300 may include one or more additional processing subsystems 302, memory subsystems 304, and/or networking subsystems 306. Alternatively, one or more of the subsystems may not be present in computer system 300.

In some embodiments, computer system 300 may include one or more additional subsystems that are not shown in FIG. 3. For example, computer system 300 can include, but is not limited to, a data collection subsystem, an audio subsystem, an alarm subsystem, a media processing subsystem, and/or an input/output (I/O) subsystem.

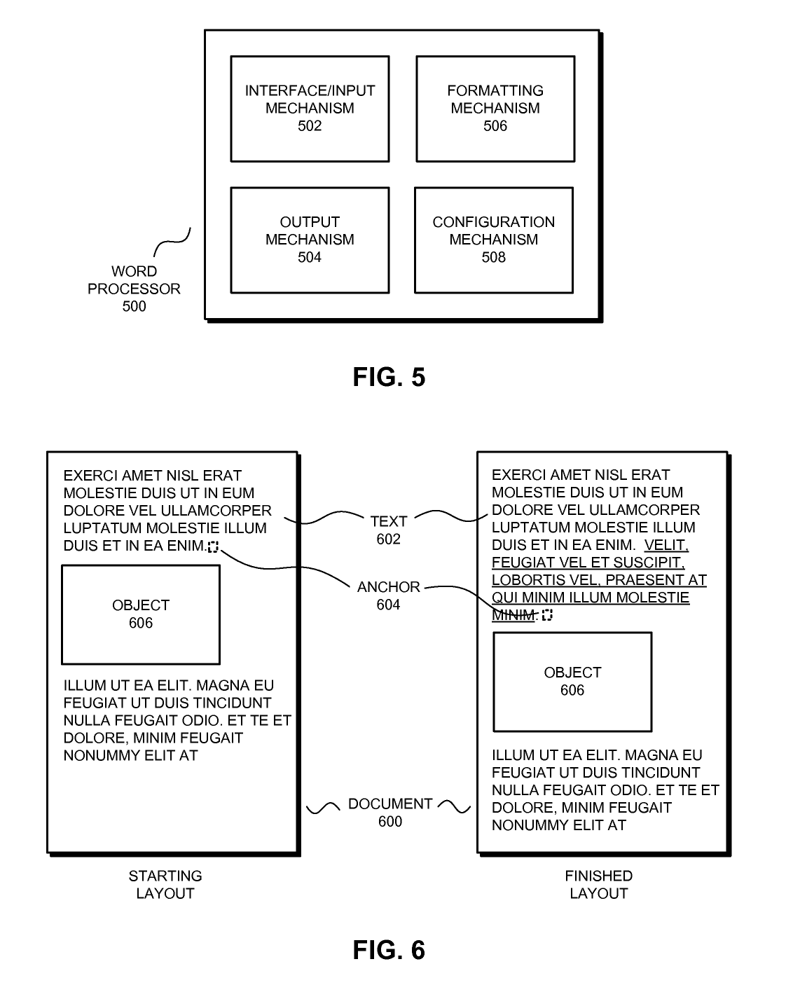

FIG. 4 presents a block diagram illustrating a network 400 in accordance with the described embodiments. As shown in FIG. 4, network 400 is coupled to computer system 300, device 402, and server 404. Generally, network 400 can include any wired or wireless connections and/or devices used for electronically transferring data between computer system 300, device 402, and/or server 404. For example, network 400 can be, but is not limited to, the Internet, a wired or wireless local-area network (LAN), or a wide area network (WAN). Networks are generally known in the art and hence are not described in detail.

Device 402 can be any device that can use a locally or remotely executed word processor that automatically places anchor points for objects in documents. For example, device 402 can be a desktop computer, a laptop computer, a server, a media player, an appliance, a subnotebook/netbook, a cellular phone, a network appliance, a tablet computer, a terminal, a set-top box, a PDA, a smart phone, a toy, a controller, or another device.

Server 404 can include any system that includes one or more mechanisms for servicing requests from a “client” system such as computer system 300 or device 402 for computational and/or data-storage resources. In some embodiments, server 404 is a server which hosts applications that can be accessed remotely and used by other systems (e.g., computer system 300 or device 402) coupled to network 400. For example, in some embodiments, server 404 is a web server that provides applications that can be accessed by the other systems using a web browser or another client application on those systems. In some of these embodiments, server 404 can host a word processor that can be accessed using a web browser or another client application in the other systems.

Although we present network 400 in FIG. 4 as an exemplary embodiment of a network 400, alternative embodiments use different types or configurations of networks, or multiple separate networks. In addition, alternative embodiments may include more or fewer devices coupled to network 400, or different types of devices coupled to network 400. Generally, in the described embodiments, one or more devices that can locally or remotely execute a word processor that automatically sets anchor points for objects in documents are coupled to a network for communicating between one another.

### Word Processor

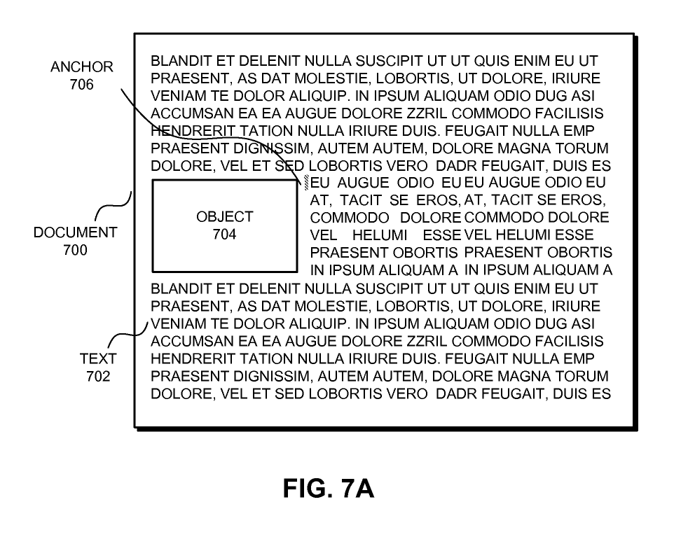

The described embodiments provide a word processor 500 (see FIG. 5) that automatically sets anchor points for objects in a document. Generally, word processor 500 is an application that enables users to create, edit, and perform operations on documents and other files (for clarity and simplicity, we refer to all the types of files that can be created, edited, or operated on by word processor 500 collectively as “documents”). The documents can include both text and objects. For example, word processor 500 can be, but is not limited to, a word processor such as Pages from Apple Inc., of Cupertino, Calif.; Word from Microsoft Inc., of Redmond, Wash.; or another word processor.

Word processor 500 includes numerous mechanisms to enable a user to create; input, configure, and remove text; input, configure, and remove objects; modify; convert; translate; format; output (e.g., print or display); and otherwise interact with documents. FIG. 5 presents a block diagram illustrating a word processor 500 in accordance with the described embodiments. As shown in FIG. 5, word processor 500 includes interface/input mechanism 502, output mechanism 504, formatting mechanism 506, and configuration mechanism 508.

Interface/input mechanism 502 is an exemplary mechanism that provides the user interface (i.e., the graphical user interface) and receives user input for word processor 500. Output mechanism 504 is an exemplary mechanism that provides file output, display, printing, and other output for word processor 500. Formatting mechanism 506 is an exemplary mechanism that provides formatting for documents and other types of files being created or modified using word processor 500. Configuration mechanism 508 is an exemplary mechanism that provides user-configurable settings for customizing the operation of word processor 500.

Although we present the simplified mechanisms in word processor 500 as examples, alternative embodiments can include more, fewer, and/or different mechanisms. In addition, although we present these mechanisms as separate mechanisms in word processor 500, in some embodiments some or all of the mechanisms (or the functions of the mechanisms) can be combined. Generally, the mechanisms not shown in FIG. 5, but that are typically present in word processors are known in the art and hence are not described in detail.

In some embodiments, word processor 500 is executed locally by processing subsystem 302 in computer system 300. In these embodiments, the files and data for word processor 500 can be stored in memory subsystem 304 or can be retrieved from another device over a network using networking subsystem 306. In addition, display subsystem 308 can display the document or file being created or modified using word processor 500, and input subsystem 310 can accept user inputs and commands to create or modify the document or file.

In alternative embodiments, a host computer system such as server 404 executes word processor 500 for a client device. For example, the client device in these embodiments can be computer system 300, device 402, or another device. In these embodiments, server 404 can transfer data for displaying the word processor 500's user interface across network 400 to the client. A user of the client device can then perform operations using word processor 500's interface on the client device and the client device can forward the user's input to server 404. In these embodiments, server 404 can perform most of the computational operations for executing word processor 500 (with the exception of displaying the interface to the user and receiving/forwarding user input) and storing information and data for word processor 500. In these embodiments, assuming that computer system 300 is the client, display subsystem 308 can display the document or file being created or modified using word processor 500 from data received from server 404, and input subsystem 310 can accept user inputs and commands to create or modify the document or file and forward the input and commands to server 404 using networking subsystem 306.

In some embodiments, server 404 provides the interface for word processor 500 to the client device using a web interface. Thus, in the client device, the user interface for word processor 500 can be accessed using a web browser or another client application.

Note that although we describe word processor 500 as a “word processor,” the described embodiments are not limited to word processors. Generally, any application that can place an anchor for an object in a document can operate in the same way. For example, email programs, text editors, web browsers, and many other programs can perform the indicated operations. In addition, although we describe the embodiments using “documents,” the documents in the described embodiments can include any type of file that can include text and/or objects (e.g., word processor documents, PDF files, bitmap images, architectural drawings, image files, web pages, etc.).

### Placing Objects and Corresponding Anchors in a Document

In the described embodiments, word processor 500 can automatically place anchors for objects in documents. More specifically, in the described embodiments, word processor 500 can dynamically arrange the text and/or other objects in the document around an object as the user is moving the object in the document. When the user then stops moving the object and places the object in a given location in the document, word processor 500 can retain the last dynamic arrangement of the text and/or other objects around the object, thereby leaving the document as the document appeared to the user as the user stopped moving the object. Word processor 500 can then determine a location for the anchor and place the anchor in the determined location. In these embodiments, the placement of the anchor does not cause word processor 500 to rearrange the text and/or other objects around the object. However, the anchor can be used to determine the arrangement of text and/or other objects with respect to the object in subsequent editing operations (e.g., entering new text and/or objects, etc.).

In the described embodiments, an object can be any object that can be placed and/or moved within a document. For example, the object can be, but is not limited to, an image or picture; a table or chart; a graphic; a field; a symbol; a reference; a heading; a file; a title; a file or an object copied from a file; and/or a list. In addition, the object can be a composite object including two or more of these objects.

In the described embodiments, a section of text can be any amount of text within a document, from a single character to thousands of characters or words on multiple pages. The section of text can include an unformatted, simple block of plain text. Alternatively, the section of text can include text with formatting including: (1) section formatting, such as paragraphs, breaks, white space, indentations, and line spacing; (2) text formatting, such as bolding, italicization, font sizing, and/or spacing; and/or (3) other types of formatting, including internal word processor document format indicators and controls.

In the described embodiments, content within a document can include any combination of section(s) of text and/or object(s). As one example, content can include two sections of text with an image or table between them. As another example, content can include a single section of text or object.

In the described embodiments, an anchor is an indicator used by word processor 500 to keep track of a location where an object is placed in a document. Generally, an anchor can be used to determine the behavior of the object, nearby text, and/or other objects with respect to the anchor point, including the arrangement of added text, the point where the corresponding object is selected, etc.

In some embodiments, the anchor is a special character that can be inserted in a document near the object's location. In these embodiments, because the anchor is a special character (and not a “normal” character, such as a character of text or a symbol), word processor 500 may not display the anchor in the document except when the object has been selected by the user, or in designated views of the document. For example, word processor 500 can display anchor(s) in the document when the user has configured word processor 500 to show special characters, but otherwise does not display the anchor.

In some embodiments, the special character that represents the anchor is treated as an invisible character of text by word processor 500. Thus, a section of text in which an object is located can include an invisible anchor character at the point where the anchor is located. (“Invisible” as used here means that word processor 500 does not display the character to the user unless the user has configured word processor 500 to display the character; however, the character is present in the document's file.)

Note that, although we describe embodiments where the anchor is a special character, in alternative embodiments, the anchor can be another type of indicator, such as a pointer, a reference in a table associated with the document, etc. Although the anchors in these embodiments may be kept differently by word processor 500, these alternative embodiments function in a similar way to the described embodiments.

In some embodiments, an object can be configured by a user so that the anchor stays at a given position with respect to text and/or other objects in the document. When the anchor is configured in this way, as text is added to the document before/above the point where the anchor is located, the anchor moves with the text. Because the anchor moves, the corresponding object can also move. Text added after/below the anchor point has no effect on the position of the anchor point in the document. In some embodiments, as described below, the object can alternatively be configured by a user so that word processor 500 dynamically updates a position of the anchor as text is entered before the anchor in a document (and hence the anchor may not stay at the same position with respect to text and/or other objects in the document). In these embodiments, word processor 500 maintains the position of the object for the anchor relative to text and/or other objects in the document.

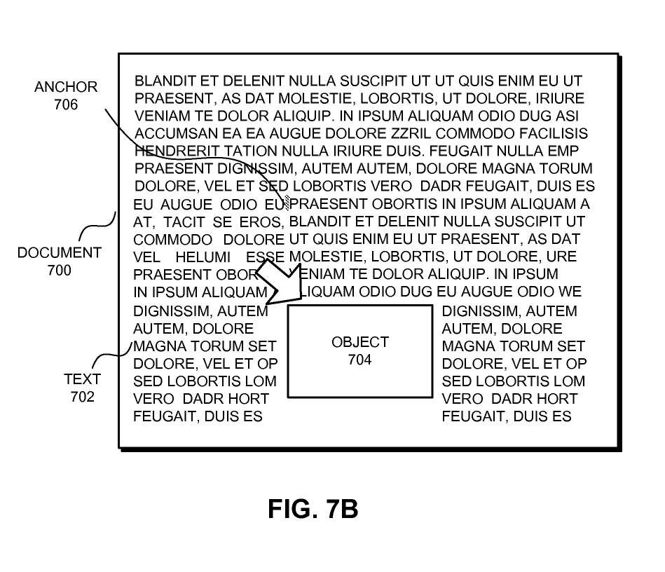

FIG. 6 presents a block diagram illustrating a document 600 that includes an anchor 604 that moves as text is added to document 600 in accordance with the described embodiments. The embodiment of word processor 500 described with respect to FIG. 6 renders anchor 604 as an invisible character of text as described above. Hence, anchor 604 is illustrated in FIG. 6 as a box with a dashed outline that represents a single invisible character in text 602.

As shown on the left side of FIG. 6, document 600 starts in a “starting layout” that includes two paragraphs of text 602 and object 606 located between the paragraphs of text 602. Anchor 604 is located at the end of the first paragraph of text, which causes word processor 500 to place object 606 between the paragraphs. In this embodiment, text added anywhere in the first paragraph causes the first paragraph to grow down the page, pushing the position of anchor 604 downward.

The finished layout on the right side of FIG. 6 includes text that has been added to the end of the first paragraph (shown with underlining). The added text has caused the first paragraph to become longer and hence to move anchor 604 downward. This, in turn, has caused word processor 500 to update the position in which object 600 is displayed on the page.

In some embodiments, word processor 500 includes a mechanism to enable a user to drag an object to reposition the object. For example, in some embodiments, the user can select an object by placing a mouse-controlled cursor over the object and clicking and holding a mouse button. The user can then drag the selected object by moving mouse to move the cursor. When the object has been dragged to a desired position, the user can release the mouse button to place the object.

In some embodiments, while a user is moving an object by dragging the object, the contents of the object are visible. For example, if the user is moving an image of a ball, the contents of the image (i.e., the ball) remain visible as the user drags the object to reposition the object. In addition, as described below, these embodiments can dynamically arrange text and/or other objects in the document around the object as the object is moved in the document. In addition to the displaying the contents of the object as the object is dragged, word processor 500 can display (i.e., continuously update the display to show) the dynamically-arranged text and/or other objects to the user as the object is dragged from one location to another.

In some embodiments, word processor 500 includes a mechanism that enables the user to move objects by entering a set of coordinates for the object. In addition, in some embodiments, word processor 500 includes a mechanism that enables the user to move objects by indicating (i.e., using a mouse-controlled cursor, or by entering a value) a position for a particular point in the object (i.e., the top edge, the bottom corner, etc.); or by otherwise indicating a position or location for the object in the document.

As described above, in the described embodiments, while a user is repositioning an object by dragging the object or using another mechanism, word processor 500 can be configured to dynamically rearrange text and/or other objects in the document around the object.

Word processor 500 includes one or more mechanisms to enable the dynamic arrangement of text and/or other objects around an object as the object is being repositioned. For example, in some embodiments, when rearranging the text and/or other objects, word processor 500 can represent the object being repositioned as a physical object of a given size (e.g., a number of inches, pixels, etc. in length and height). As the object is dragged or otherwise moved around the document, word processor 500 can determine if the area of the object intersects text. If so, word processor 500 can re-arrange the text around the object as if the object was placed at that location in the document. The result of this operation can be displayed to a user to provide the user an indication of what the object and the surrounding text and/or other objects would look like if the object was placed at that location.

In some embodiments, when dynamically placing text and other objects around the object as the user is moving the object, word processor 500 can estimate an arrangement of text and other objects around the object using a library of template arrangements. For example, word processor 500 can include a number of layout templates that include a number of sections of text and/or other objects and can select a closest template layout when determining how to arrange the text and other objects around the object.

In the described embodiments, when the user releases a dragged object in a selected location or uses another mechanism to move an object from an initial location to a selected location, word processor 500 places the object in the location, and leaves the text in the final dynamic state. More specifically, unlike in some existing word processors, when the object is repositioned to a given position, word processor 500 does not first place the anchor in the indicated location and then arrange the text and other objects around the object according to the position of the anchor. Instead, word processor 500 places the object in the location with the text and/or other objects arranged as they were displayed to the user in the final dynamic arrangement and then places the anchor in a corresponding location. Note that placing the anchor does not involve rearranging the text and/or other objects with respect to the object.

After an object has been placed with the text and/or other objects arranged according to the final dynamic arrangement, word processor 500 places the anchor in a position in the document that corresponds to the repositioned object. More specifically, word processor 500 determines semantic elements of the text and/or other objects around the repositioned object and then uses these semantic elements to place the anchor in the determined location.

For example, in some embodiments, word processor 500 can determine semantic elements such as, but not limited to, the amount of whitespace around a repositioned object, the position of the object in the page (e.g., distance from edges, distance from corners, etc.), the characters at the end of the line before and the beginning of the line after the repositioned object, the shape or size of the object, the spacing or font size of the text, the edges of the object, punctuation marks, page or section breaks, and/or the arrangement of nearby sections of text (i.e., paragraph breaks, line breaks, etc.).

In these embodiments, word processor 500 uses the semantic element(s) to determine where and how the object appears to a user relative to text and other objects, and places the anchor relative to the semantic element(s). In some embodiments, using the semantic elements can involve avoiding placing the anchor in certain locations, such as mid-word (instead, word processor 500 sets the anchor at the end of the word, the end of the line, etc.).

In the described embodiments, word processor 500 enables a user to “drag-select” two or more characters of text and/or objects by placing a mouse-controlled cursor in a given location, pressing a predetermined mouse button and/or keyboard button, and dragging the mouse cursor over the text and/or objects to select the text and/or objects.

In some embodiments, when determining where to place the anchor after placing the object in a given location, word processor 500 determines the location based on an estimated expectation of a user where the object is selected during a drag-select operation in the area around the object. For example, if word processor 500 projects that the user will expect the object to be selected as the user drags the cursor over the object from left-to-right, word processor can place the anchor in a corresponding location (e.g., a top corner of the object or a leftmost edge of the object). Although we use a mouse-controlled cursor to illustrate drag-selecting an object, in some embodiments, the word processor 500 enables a user to drag-select the text and/or objects in a similar way using a stylus, a set of keystrokes on a keyboard, a finger on a touch screen, or another mechanism.

In some embodiments, word processor 500 supports numerous different layout formats for content (text and objects) on a page. For example, the layouts can include column formats, multiple pages on a page, etc. In these embodiments, when determining where to place the anchor for an object after the object has been repositioned, word processor 500 determines a layout of the page and uses the layout of the page as one of the factors considered when determining where to place the anchor.

Unlike in existing systems, in some embodiments, word processor 500 does not display the anchor to the user while the user is repositioning an object. In these embodiments, the anchor may not be displayed at all, or may be displayed only after word processor 500 places the anchor based on the location of the repositioned object. This can avoid the case where the user (who may be accustomed to placing the anchor instead of placing the object) becomes frustrated by what is perceived as an inconsistency between the location of the anchor with the object.

In alternative embodiments, the anchor is displayed as the user is moving an object (i.e., when the user has configured word processor 500 to display the anchor), but is displayed in a location computed for the placement of the anchor based on the location of the object with respect to text and/or objects around the object. More specifically, in these embodiments, the position of the anchor is determined by word processor 500 as word processor 500 dynamically arranges text and/or other objects around the object being repositioned as described above.

In the described embodiments, because word processor 500 dynamically updates the position of text and other objects in the document as a given object is dragged or otherwise moved to reposition the object, and because word processor 500 places the object where the user puts it, leaving the text in the last position from the dynamic updates, and simply setting the anchor in a corresponding location without rearranging text and/or other objects, word processor 500 presents the user with a more accurate representation of the user's actions on the final outcome of repositioning an object.

As described above, in some embodiments, word processor 500 can be configured to update the anchor as text is added to a document. For example, assuming that an anchor is located at the midpoint of a given line and that word processor 500 is configured to update the anchor position as text is added. As the user enters text, word processor 500 determines a position for the anchor based on an assumption about what the text is supposed to look like. For example, if a user adds text to a line at the end of a paragraph, but after an original position of an anchor for an object below the paragraph, instead of placing the new text below the object (as might be caused by the anchor otherwise), word processor 500 maintains the anchor at the end of the line. This can keep the new text with the paragraph above the object, as is likely desired by the user.

In some embodiments, word processor 500 moves the anchor at a minimum movement resolution supported by word processor 500. In other words, the user need only move an object by the minimum movement resolution supported by word processor 500, and word processor 500 re-determines the location for placing the anchor. For example, in some embodiments, word processor 500 can use a movement resolution of a single character, a numeric value of length (e.g., millimeters, inches, points, etc.), or another resolution. In these embodiments, when the object is moved, word processor 500 may not update the anchor point until the anchor point shifts by a sufficient amount. In alternative embodiments, the threshold for redetermining the position of the anchor is higher (i.e., the anchor position is not redetermined until the object has been moved some minimum distance).

In some embodiments, word processor 500 is configured so that the anchor for a given object can appear in only a certain number of locations with respect to the object (or to the text around the object or other objects). For example, assuming that the object is a circular object, word processor 500 can be configured so that the anchor can appear at the topmost point, the leftmost and rightmost points, and the bottommost point of the circle.

Note that, in this description, we describe operations such as “placing a mouse-controlled cursor over an object.” Generally, these descriptions refer to operations occurring on a display (e.g., a touch screen or the screen of a monitor), in a way that is well known in the art.

The anchor placement operation in the described embodiments differs from anchor placement operations in existing word processors because existing word processors place the anchor at a location indicated by a user and then position the object according to the location of the anchor. The existing word processors then arrange the nearby text and other objects according to the placement of the anchor, which often leads to an unexpected arrangement of the text and objects. The described embodiments avoid this by maintaining an arrangement of text and/or other objects displayed to a user for a repositioned object and then placing the anchor in a corresponding location without rearranging the text and/or other objects.

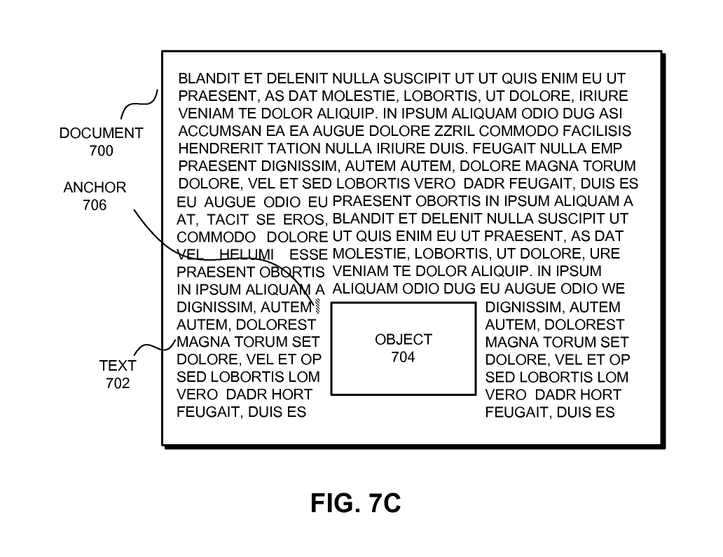

FIGS. 7A-7C present block diagrams illustrating the repositioning of an object 704 in a document 700 in accordance with the described embodiments. More specifically, FIGS. 7A-7C present several different views of a document 700 that is being edited in word processor 500 in accordance with the described embodiments. In some embodiments, the views can be generated by word processor 500 and displayed by display subsystem 308 on a display (i.e., a monitor, a screen on a device, etc.) for viewing by a user.

As shown in FIG. 7A, object 704 is initially located in a section of text 702 near a left edge of document 700. In addition, anchor 706 is initially placed above and to the right of object 704. Note that anchor 706 can have been placed by word processor 500 in an earlier repositioning operation (or initial positioning) operation.

A user then moves object 704 down and to the right (i.e., selected and dragged object 704) within the section of text 702 in document 700, as shown in FIG. 7B. As described above, word processor 500 has dynamically rearranged the text 702 in the section of text 702 to display to a user the arrangement of the section of text 702 should object 704 be located in the position the user has placed it. Specifically, word processor 500 has dynamically placed text 702 where object 704 was initially located and arranged text 702 around the new location for object 704. Note that anchor 706 has not yet been moved by word processor 500.

The user then selects the position for object 704 shown in FIG. 7B as a final position for object 704. Next, as shown in FIG. 7C, word processor 500 places anchor 706 in a corresponding location, but does not rearrange the text 702. As can be seen, word processor 500 has placed anchor 706 near a top left corner of object 704. However, in alternative embodiments, word processor 500 can place anchor 706 in other locations, such as near a bottom right corner of object 704, etc.

### Process for Placing Objects and Corresponding Anchors in a Document

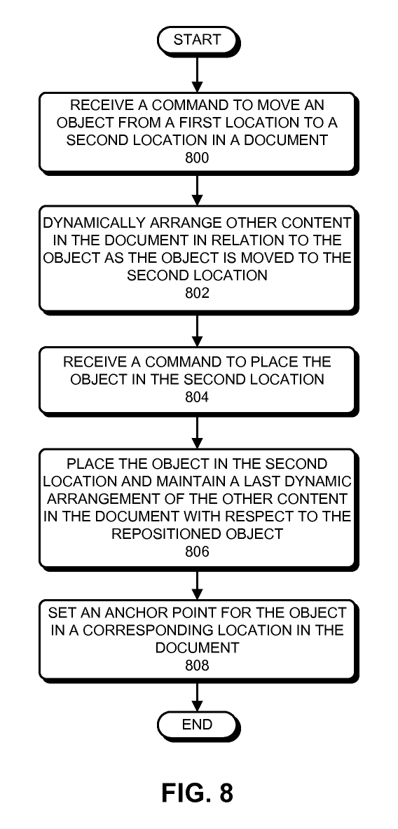

FIG. 8 presents a flowchart illustrating a process for repositioning an object in a document in accordance with the described embodiments. More specifically, FIG. 8 illustrates a process for repositioning an object and placing the object's anchor in a way that maintains an appearance of other content (i.e., a text and/or other objects) in a document in word processor 500.

Note that we use the term “other content,” as described above, to denote any type of content, including any section(s) of text and/or other objects around the object being repositioned. In addition, in the following example, we describe operations such as “placing a mouse-controlled cursor over an object.”Generally, these descriptions refer to operations occurring on a display (e.g., a touch screen or the screen of a monitor), in a way that is well known in the art.

The process in FIG. 8 starts when word processor 500 receives a command to move an object from a first location to another location in a document (step 800). As described above, the object can be any object or combination of objects that can be moved in a document.

In some embodiments, receiving the command to move the object can involve a user selecting the object using a mouse-controlled cursor, a stylus, a finger on a touch screen, and/or another selection mechanism, and dragging the selected object from the first location to the second location. For example, a user can place a mouse-controlled cursor over the object and press and hold a mouse button to select the object, and can then move the mouse to drag the selected object within the document.

Alternatively, receiving the command to move the object can involve receiving an indication of an object (i.e., a click of a mouse, a selection in a selection menu, a tap of a finger on a touch screen) and a location where the object is to be moved. For example, a user can place a mouse-controlled cursor over the object.

As the object is moved from the first location to the second location, word processor 500 dynamically arranges other content in the document in relation to the object (step 802).

Word processor 500 then receives a command to place the object at the second location (step 804). For example, word processor 500 can determine that the user has released the mouse button to stop dragging the object, or has otherwise indicated an acceptance of a position of the object.

Word processor 500 then places the object in the second location, maintaining the last (most recent) dynamic arrangement of the other content in the document with respect to the repositioned object (step 806). In placing the object in this way, word processor 500 maintains the text and/or other objects in an arrangement anticipated by the user.

Word processor 500 then sets an anchor point for the object in a corresponding location in the document (step 808). As described above, word processor 500 can use semantic elements, document configuration, or other mechanisms for determining where to place the anchor. As also described above, word processor 500 does not rearrange the other content after placing the anchor, so the other content remains in the last dynamic arrangement.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for formatting a document in a word processor, comprising:
in response to receiving a command to move an object in the document, moving the object in the document, wherein moving the object in the document includes dynamically arranging other content in the document with respect to the object as the object is moved;
in response to receiving a command to place the object at a specified location while moving the object, placing the object at the specified location and leaving the other content arranged with respect to the object in accordance with a most recent dynamic arrangement of the other content;
after placing the object at the specified location, determining an anchor location for an anchor for the object; and
placing an anchor for the object at the anchor location.

2. The method of claim 1, wherein receiving the command to move the object includes receiving a selection of the object from a user and a command to drag or otherwise move the object to the specified location; and
wherein receiving the command to place the object at the specified location includes receiving a command to stop dragging or moving the object and to place the object at the specified location.

3. The method of claim 1, wherein before receiving the command to move the object, the object is located at an initial location, wherein the initial location is associated with a corresponding initial anchor location; and
until the anchor for the object is placed at the anchor location, the method further comprises keeping the anchor at the initial anchor location.

4. The method of claim 1, wherein the method further comprises displaying the object and the dynamically arranged content to a user as the object is moved.

5. The method of claim 1, wherein placing an anchor for the object at the anchor location includes leaving the other content arranged with respect to the object in accordance with the most recent dynamic arrangement of the other content.

6. The method of claim 1, wherein determining the anchor location includes:
determining a location or property of at least one semantic element of the other content; and
using the determined location or property to determine the anchor location for the anchor.

7. The method of claim 6, wherein determining the anchor location further comprises determining a location where a user will expect to select the object during a drag-select operation; and
adjusting the anchor location to account for the location where the user will expect to select the object during the drag-select operation.

8. The method of claim 1, wherein the method further comprises:
after placing the anchor at the anchor location, receiving text or other objects to add to the other content;
adding the text or other objects to the other content; and
arranging other content around the object in accordance with the location of the anchor.

9. The method of claim 1, wherein moving the object includes determining if the word processor has been configured not to display the anchor for the object as the object is moved and, if so, not displaying the anchor for the object as the object is moved.

10. The method of claim 1, wherein the method further comprises:
after placing the anchor at the anchor location, receiving text or other objects to add to the other content;
adding the text or other objects to the other content; and
repositioning the anchor to maintain the arrangement of the other content with respect to the object.

11. The method of claim 1, wherein performing the method includes executing the word processor in a processing subsystem.

12. A computer-readable storage medium for storing instructions that when executed by a computer cause the computer to perform a method for formatting a document in a word processor, comprising:
in response to receiving a command to move an object in the document, moving the object in the document, wherein moving the object in the document includes dynamically arranging other content in the document with respect to the object as the object is moved;
in response to receiving a command to place the object at a specified location while moving the object, placing the object at the specified location and leaving the other content arranged with respect to the object in accordance with a most recent dynamic arrangement of the other content;
after placing the object at the specified location, determining an anchor location for an anchor for the object; and
placing an anchor for the object at the anchor location.

13. The computer-readable storage medium of claim 12, wherein receiving the command to move the object includes receiving a selection of the object from a user and a command to drag or otherwise move the object to the specified location; and
wherein receiving the command to place the object at the specified location includes receiving a command to stop dragging or moving the object and to place the object at the specified location.

14. The computer-readable storage medium of claim 12, wherein before receiving the command to move the object, the object is located at an initial location, wherein the initial location is associated with a corresponding initial anchor location, and until the anchor for the object is placed at the anchor location, the method further comprises keeping the anchor at the initial anchor location.

15. The computer-readable storage medium of claim 12, wherein the method further comprises displaying the object and the dynamically arranged content to a user as the object is moved.

16. The computer-readable storage medium of claim 12, wherein placing an anchor for the object at the anchor location includes leaving the other content arranged with respect to the object in accordance with the most recent dynamic arrangement of the other content.

17. The computer-readable storage medium of claim 12, wherein determining the anchor location includes:
determining a location or property of at least one semantic element of the other content; and
using the determined location or property to determine the anchor location for the anchor.

18. The computer-readable storage medium of claim 17, wherein determining the anchor location further comprises determining a location where a user will expect to select the object during a drag-select operation; and
adjusting the anchor location to account for the location where the user will expect to select the object during the drag-select operation.

19. The computer-readable storage medium of claim 12, wherein moving the object includes determining if the word processor has been configured not to display the anchor for the object as the object is moved and, if so, not displaying the anchor for the object as the object is moved.

20. An apparatus for formatting a document in a word processor, comprising:
a processing subsystem, wherein the processing subsystem is configured to:
upon receiving a command to move an object in the document, move the object in the document, wherein moving the object includes dynamically arranging other content in the document with respect to the object as the object is moved;
upon receiving a command to place the object at a specified location while moving the object, place the object at the specified location and leave the other content arranged with respect to the object in accordance with a most recent dynamic arrangement of the other content;
after placing the object at the specified location, determine an anchor location for an anchor for the object; and
place an anchor for the object at the anchor location.
